(19) United States
(12) Patent Application Publication
(10) Pub. No.: US 2020/0316550 A1
(43) Pub. Date: Oct. 8, 2020

(54) THIOL-EPOXY BASED AEROGELS

(71) Applicants: Henkel AG & Co. KGaA, Duesseldorf (DE); Henkel IP & Holding GmbH, Duesseldorf (DE)

(72) Inventors: Belen Del Saz-Orozco Rodriguez, Las Rozas de Madrid (ES); Ilaria De Santo, Naples (ES); Asta Sakalyte, Sant Salvador (Tarragona) (ES); Elisabeth Torres Cano, Barcelona (ES); Fouad Salhi, Farmington, CT (US)

(21) Appl. No.: 16/906,682

(22) Filed: Jun. 19, 2020

Related U.S. Application Data
(63) Continuation of application No. PCT/EP2018/084569, filed on Dec. 12, 2018.

(30) Foreign Application Priority Data
Dec. 19, 2017 (EP) 17382861.7

(51) Int. Cl. B01J 13/00; C08G 59/24; C08G 59/68; C08G 59/30; C08G 59/32

(52) U.S. Cl. CPC B01J 13/0091; B01J 13/0065; B01J 13/0069; C08G 59/245; C08G 2101/0091; C08G 59/302; C08G 59/32; C08G 2330/00; C08G 59/686

(57) ABSTRACT

The present invention relates to an organic aerogel obtained by reacting a thiol compound having a functionality from 2 to 6 and an epoxy compound having a functionality from 2 to 6 in a presence of a solvent. The organic aerogels according to the present invention are hydrophobic, high performance materials (lightweight, with low thermal conductivity, low shrinkage, and high mechanical properties).

### TECHNICAL FIELD

The present invention relates to an organic aerogel obtained by reacting a thiol compound and an epoxy compound in a presence of a solvent. The aerogels according to the present invention are hydrophobic, high performance materials (lightweight, with low thermal conductivity, low shrinkage, and high mechanical properties).

### BACKGROUND OF THE INVENTION

Aerogels are known for being very good insulating materials due to their nanostructure and morphology. Literary describes both inorganic and organic aerogels.

Inorganic aerogels are mostly made of silica, providing good insulating properties, however, their mechanical properties are poor, and have problems related to airborne particles.

Organic aerogels have shown improved mechanical properties compared to inorganic aerogels. In addition, organic aerogels are not dusty. Many different organic aerogels have been described in the literature. These organic materials are based on polymeric networks of different nature, formed by the cross-linking of monomers in solution to yield a gel that is subsequently dried to obtain a porous material.

First organic aerogels described in the literature were based on phenol-formaldehyde resins. Other significant group of organic aerogels is based on materials prepared using multifunctional isocyanates. These monomers can be used to prepare polyimide aerogels (by reaction with anhydrides), polyamide aerogels (by reaction with carboxylic acids), polyurethane aerogels (by reaction with hydroxylated compounds) and polycarbodiimide aerogels or polyurea aerogels.

Both inorganic and organic aerogels are generally hydrophilic. To improve hydrophobicity of aerogels, the surface can be hydrophobized by a modification solution, where surface groups could be replaced by hydrophobic groups, typically, trimethylsilyl (TMS). The TMS groups are most often introduced through trimethylchlorosilane (TMCS), hexamethyldisilazane (HMDZ), or hexamethyldisiloxane (HMDSO) hydrophobization agents.

An alternative, more direct route to synthesize open-porous, hydrophobic materials, is to use precursors that already contain chemically bound hydrophobic groups, for example, methyltri(m)ethoxysilane (MTMS/MTES) or dimethyldimethoxysilane (DMDMS).

Crosslinking is another method used to improve water resistance of aerogels. In this method, hydrophilic groups are substituted, and the three-dimensional network is formed. Surface coating could also be an option to improve both the compressive strength and water resistance of aerogels. This is achieved by forming rigid and hydrophobic layers on the surfaces.

However, all these approaches are disadvantageous because they add an extra step in the material preparation process, and therefore, increase production time and the production costs.

A superhydrophobic thiourethane bridged polysilesquioxane aerogels, i.e. organic-inorganic molecular hybrid, have been developed for thermal insulation. In this case, the isocyanate group is straight bonded covalently to a Si atom at the molecular level. These aerogels are hydrophobic and show remarkable low thermal conductivity values (18-20 mW/mK). However, their compressive mechanical properties are very low: the compressive modulus was lower than 1 MPa, and therefore, they are not suitable for applications that require high mechanical performance.

Thermoresponsive shape-memory aerogels have been described in the literature. These aerogels are based on reacting thiols and an alkene through alkene hydrothiolation reaction to form a thiolene network. These aerogels are very flexible and show low porosity (72-81%) and low surface area (5-10 m²/g).

Aerogels prepared from a thiolene clicked bridged silsesquioxane precursor are also described in the literature. The thioether bridge provides the aerogel with low polarity and high flexibility. The thermal conductivity of these materials is rather high of about 47.1-56.5 mW/m·K and the compressive modulus is about 0.029-0.12 MPa.

In addition, there are several different kind of organic aerogels described in the literature, among other aerogels based on isocyanate and cyclic ether polymer networks, benzoxazine based copolymer aerogels, hybrid aerogels based on isocyanate—cyclic ether—clay networks and organic aerogels based on amine/oxirane polymer networks.

There is still a need to provide organic aerogels, which are hydrophobic, stable and non-flammable.

### SUMMARY OF THE INVENTION

The present invention relates to an organic aerogel obtained by reacting a thiol compound having a functionality from 2 to 6 and an epoxy compound having a functionality from 2 to 6 in a presence of a solvent.

The present invention also relates to a method for preparing an organic aerogel according to the present invention comprising the steps of: 1) dissolving an epoxy compound into a solvent and adding a thiol compound and mixing, 2) adding a catalyst if present, and mixing; 3) letting the mixture to stand in order to form a gel; 4) washing said gel with a solvent; and 5) drying said gel by supercritical or ambient drying.

The present invention encompasses a thermal insulating material or an acoustic material comprising an organic aerogel according to the present invention.

The present invention also encompasses use of an organic aerogel according to the present invention as a thermal insulating material or acoustic material.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

The present invention relates to an aerogel obtained from the reaction of thiol-functional molecules with epoxy-functional molecules. The reactions between thiol- and epoxy-functional groups in a solvent result in a network based on thiol-epoxy linkages.

The reaction between a thiol and an epoxy functional groups is illustrated in scheme 1 below. The end-product is a thioether linkage and a secondary hydroxyl group.

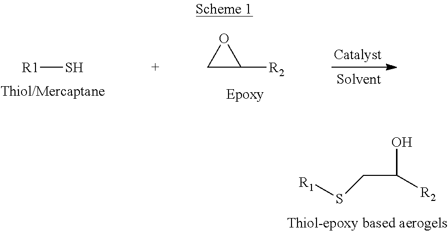

Organic aerogels according to the present invention are hydrophobic, stable and non-flammable. Furthermore, the organic aerogels according to the present invention are high performance materials, they are lightweight, with low thermal conductivity, low shrinkage, and high mechanical properties.

An organic aerogel according to the present invention is obtained by reacting a thiol compound having a functionality from 2 to 6 and an epoxy compound having a functionality from 2 to 6 in a presence of a solvent.

Suitable thiols for use in the present invention can be primary or secondary, aliphatic or aromatic.

Suitable thiol compound for use in the present invention has a functionality from 2 to 6, preferably from 2 to 4.

Suitable thiol compound for use in the present invention has a functionality from 2 to 4 and is selected from the group consisting of

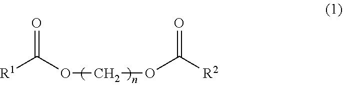

wherein n is 2-10, R¹ and R² are same or different and are independently selected from —CH₂—CH(SH)CH₃ and —CH₂—CH₂—SH;

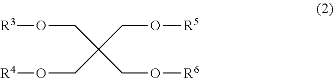

wherein R³, R⁴, R⁵ and R⁶ are same or different and are independently selected from —C(O)—CH₂—CH₂—SH, —C(O)—CH₂—CH(SH)CH₃, —CH₂—C(—CH₂—O—C(O)—CH₂—CH₂—SH)₃, —C(O)—CH₂—SH, —C(O)—CH(SH)—CH₃;

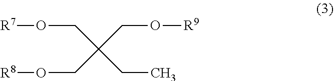

wherein R⁷, R⁸ and R⁹ are same or different and are independently selected from —C(O)—CH₂—CH₂—SH, —C(O)—CH₂—CH(SH)CH₃, —[CH₂—CH₂—O—]O—C(O)—CH₂—CH₂—SH, —C(O)—CH₂—SH, —C(O)—CH(SH)—CH₃ and o is 1-10;

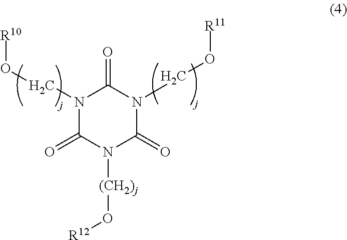

wherein j is 2-10, R¹⁰, R¹¹ and R¹² are same or different and independently selected from —CH₂—CH₂SH, —CH₂—CH(SH)CH₃, —C(O)—CH₂—SH, —C(O)—CH(SH)—CH₃ and mixtures thereof.

Preferably, said thiol compound is selected from the group consisting of glycol di(3-mercaptopropionate), pentaerythritol tetrakis (3-mercaptobutylate). 1,3,5-tris(3-mercaptobutyloxethyl)-1,3,5-triazine-2,4,6(1H,3H,5H)-trione, 1,4-bis (3-mercaptobutylyloxy) butane, tris[2-(3-mercaptopropionyloxy)ethyl]isocyanurate, pentaerythritol tetra(3-mercaptopropionate), trimethylolpropane tris(3-mercaptopropionate), trimethylolpropane tris(3-mercaptobutyrate) ethoxylated-trimethylolpropan tri-3-mercaptopropionate, dipentaerythritol hexakis (3-mercaptopropionate) and mixtures thereof.

Preferred thiols optimise the performance of the aerogels according to the present invention.

Suitable commercially available thiol compounds to be used in the present invention are for example KarenzMT BD1 and KarenzMT PE1 from Showa Denko Europe GmbH, PETMP from Bruno Bock.

Preferably, the thiol compound is present in the reaction mixture from 0.4-40% by weight of the total weight of the reaction mixture (including solvent), more preferably from 0.45 to 25% and even more preferably from 0.5 to 18%.

An organic aerogel according to the present invention is obtained by reacting a thiol compound and an epoxy compound. Suitable epoxy compound for use in the present invention can be aliphatic or aromatic.

Suitable epoxy compound for use in the present invention has a functionality from 2 to 6, preferably from 2 to 4.

Suitable epoxy compound for use in the present invention has a functionality from 2 to 4 and is selected from the group consisting of

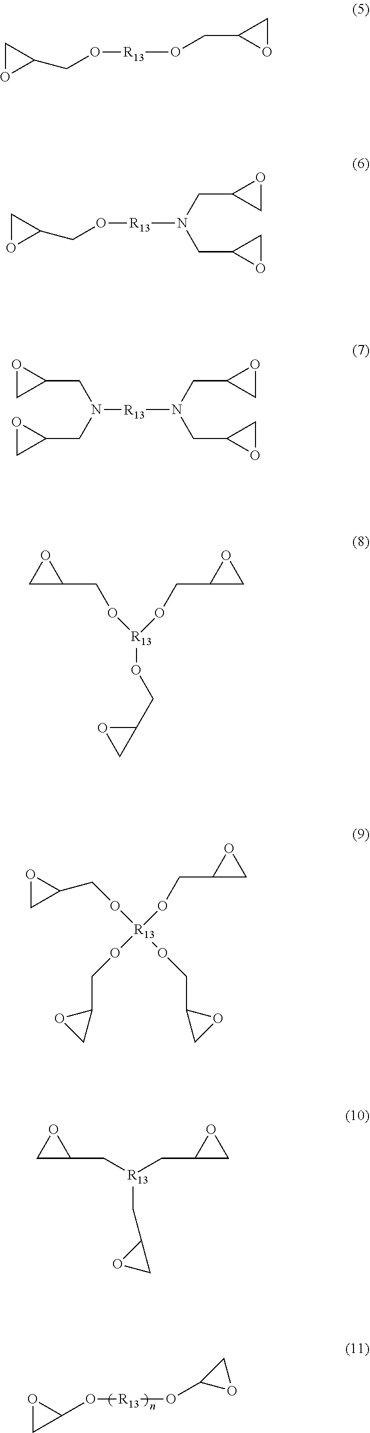

wherein R₁₃ is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is integer 1 to 30, and mixtures thereof.

Preferably said epoxy compound is selected from the group consisting of N,N-diglycidyl-4-glycidyloxyaniline, phenol novolac epoxy resins, tetraglycidyl ether of 1,1,2,2-tetrakis(hydroxyphenyl)ethane, N,N,N′,N′-tetraglycidyl-4,4′-methylenebisbenzenamine, Bisphenol A—diglycidyl ether and mixtures thereof.

These eopoxy compounds are preferred because they will provide aerogels having low thermal conductivity.

Suitable commercially available epoxy compounds to be used in the present invention are for example Araldite MY05101 and Araldite DY-D from Huntsman and Bisphenol A diglycidyl ether from Alfa Aesar.

Preferably, the epoxy compound is present in the reaction mixture from 0.3 to 40% by weight of the total weight of the reaction mixture (including solvent), more preferably from 0.3 to 36%, more preferably from 0.4 to 18%.

In a preferred embodiment, the organic aerogel according to the present invention have the ratio of thiol groups to epoxy groups 10:1-1:10, preferably 6:1-1:6 and more preferably 3:1-1:3.

These preferred ratios provide aerogels with desired properties, and reaction and gelation times are very short especially with the range 3:1-1:3.

An organic aerogel according to the present invention is obtained by reacting a thiol compound and an epoxy compound in a presence of a solvent. Suitable solvent for use in the present invention is a polar solvent, preferably polar aprotic solvent.

The solvent used in the present invention can be selected from the group consisting of dimethyl sulfoxide (DMSO), acetone, MEK (2-butanone), MIBK (methyl isobutyl ketone) dimethylacetamide (DMAc), dimethylformamide (DMF), 1-methyl-2-pyrrolidinone (NMP), acetonitrile, chloroform and mixtures thereof.

An organic aerogel according to the present invention may be obtained in the presence of a catalyst. Scheme 1 illustrates mechanism of the formation of thiol-epoxies bonds. The reaction is a click chemistry type reaction, and it is generally very rapid reaction, when the appropriate catalyst is used. However, the reaction occurs also without a catalyst. Furthermore, the reaction is proven to be regioselective depending on adopting base or acidic conditions.

Suitable catalyst for use in the present invention is selected from the group consisting of alkyl amines, aromatic amines, imidazole derivatives, aza compounds, guanidine derivatives, benzyl alcohol and amidines.

Preferably, the catalyst is selected from the group consisting of triazabicyclodecene (TBD), triethylenediamine (TEDA), dimethylbenzylamine (DMBA), triethylamine (Et₃N), 1,4-diazabicyclo[2.2.2]octane (DABCO), dibutyltin dilaurate (DBTDL), 2,4,6-tris(dimethylaminomethyl)phenol (DMP-30), benzyl alcohol, triethanolamine and mixtures thereof.

Above-mentioned preferred catalysts are preferred because they provide faster gelation and require lower temperature for it.

Preferably, the catalyst is present in the reaction mixture from 0.5 to 30% by weight of the total weight of the reaction mixture (including solvent), preferably from 0.75 to 25% and more preferably from 1 to 20%.

Suitable commercially available catalysts to be used in the present invention are for example dimethylbenzylamine from Merck, DMP-30, benzyl alcohol, triethanolamine and triethylamine from Sigma-Aldrich.

An organic aerogel according to the present invention may further comprise a reinforcement.

Suitable reinforcement for use in the present invention may be selected from the group consisting of fibres, particles, non-woven and woven fibre fabrics, chopped strand mats, honeycombs, 3D structures and mixtures thereof.

Preferably, the reinforcement is present from 0.1 to 80% by weight of the total weight of the aerogel, preferably from 0.5 to 75%.

An organic aerogel according to the present invention has a solid content from 4 to 40%, based on initial solid content of the solution, preferably from 4.5 to 30% and more preferably from 5 to 20%.

If the solid content is below 4% it is very difficult to obtain a gel. On the other hand, when the solid content is more than 40% the material has very high density. High density typically leads also to high thermal conductivity, which is not desired property.

An organic aerogel according to the present invention has a thermal conductivity less than 75 mW/m·K, preferably less than 55 mW/m·K, more preferably less than 50 mW/m·K, and even more preferably less than 45 mW/m·K. Wherein the thermal conductivity is measured according to the test methods described below.

### Diffusivity Sensor Method

In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

### Steady-State Condition System Method

In this method the thermal conductivity is measured by using a steady-state condition system. In this method, the sample is sandwiched between a heat source and a heat sink. The temperature is risen on one side, the heat flows through the material and once the temperature on the other side is constant, both heat flux and difference of temperatures are known, and thermal conductivity can be measured.

An organic aerogel according to the present invention has a compression Young's modulus more than 0.1 MPa, preferably more than 15 MPa, and more preferably more than 30 MPa, wherein Compression Young Modulus is measured according to the method ASTM D1621.

An organic aerogel according to the present invention has preferably a compressive strength more than 0.01 MPa, more preferably more than 0.45 MPa, and even more preferably more than 3 MPa. Compressive strength is measured according to the standard ASTM D1621.

An organic aerogel according to the present invention has preferably a specific surface area ranging from 5 m²/g to 300 m²/g. Surface area is determined from N₂ sorption analysis at −196° C. using the Brunauer-Emmett-Teller (BET) method, in a specific surface analyser Quantachrome-6B.

High surface area values are preferred because they are indicative of small pore sizes, and which may be an indication of low thermal conductivity values.

An organic aerogel according to the present invention has preferably an average pore size ranging from 5 to 80 nm. Pore size distribution is calculated from Barret-Joyner-Halenda (BJH) model applied to the desorption branch from the isotherms measured by N₂ sorption analysis. Average pore size was determined by applying the following equation: Average pore size=(4*V/ SA) wherein V is total pore volume and SA is surface area calculated from BJH. Porosity of the samples can also be evaluated by He picnometry.

An aerogel pore size below the mean free path of an air molecule (which is 70 nm) is desired, because that allows obtaining high performance thermal insulation aerogels having very low thermal conductivity values.

An organic aerogel according to the present invention has low-density structure having a bulk density ranging from 0.01 to 0.8 g/cc. Bulk density is calculated from the weight of the dry aerogel and its volume.

An organic aerogel according to the present invention is resistant to low temperatures exposure (from −160° C. to 0° C.). Additionally, an organic aerogel may resist liquid nitrogen immersion (−196° C.) and subsequent evaporation.

For the preparation of organic aerogels according to the present invention, several aspects must be taken into consideration. The stoichiometric ratio of functionalities, the initial solid content, the amount and type of catalyst (if present), type of solvent, gelation time and temperature are crucial factors that affect to the final properties of the material.

In one embodiment, an organic aerogel according to the present invention is prepared according to the method comprising the steps of:
1) dissolving an epoxy compound into a solvent and adding a thiol compound and mixing,
2) adding a catalyst if present, and mixing;
3) letting the mixture to stand in order to form a gel;
4) washing said gel with a solvent; and
5) drying said gel by supercritical or ambient drying.

The reaction mixture is prepared in a closed container.

Gelation step (3) is carried out in the oven for the pre-set time and temperature. Preferably, temperature is applied on step 3, more preferably, temperature from 20 to 120° C. is applied while gel is forming, and most preferably, temperature from 25 to 90° C. is applied.

Temperatures 20 to 120° C. are preferred because of higher temperatures than 120° C. require the use of solvents with extremely high boiling points.

Gelation time is preferably from 0.5 to 72 hours, preferably from 1 to 36 hours and more preferably from 3 to 24 hours.

Washing time in step (4) is preferably from 1 hour to 96 hours, preferably from 24 hours to 48 hours.

The solvent of wet gels of step (3) is changed one or more times after the gelation. The washing steps are done gradually, and if required, to the preferred solvent for the drying process. Once the wet gel remains in the proper solvent, it is dried in supercritical (CO₂) or ambient conditions obtaining the final aerogel material.

In one embodiment, the washing steps are done gradually as follows 1) DMSO/acetone 3:1; 2) DMSO/acetone 1:1; 3) DMSO/acetone 1:3; and 4) acetone. In another embodiment, all four washing steps are done with acetone. Once the solvent has been completely replaced by acetone, gel is dried in supercritical (CO₂) or ambient conditions obtaining the final aerogel material.

In one embodiment all four washing steps are done with hexane.

The supercritical state of a substance is reached once its liquid and gaseous phases become indistinguishable. The pressure and temperature at which the substance enters this phase is called critical point. In this phase, the fluid presents the low viscosity of a gas, maintaining the higher density of a liquid. It can effuse through solids like a gas and dissolve materials like a liquid. Considering an aerogel, once the liquid inside the wet gel pores reaches the supercritical phase, its molecules do not possess enough intermolecular forces to create the necessary surface tension that creates capillarity stress. Hence, the solvent can be dried, minimizing shrinkage and possible collapse of the gel network.

The drying process at supercritical conditions is performed by exchanging the solvent in the gel with CO₂ or other suitable solvents in their supercritical state. Due to this, capillary forces exerted by the solvent during evaporation in the nanometric pores are minimized and shrinkage of the gel body can be reduced.

In one embodiment, the method for preparing the organic aerogel involves the recycling of the CO₂ from the supercritical drying step.

Alternatively, wet gels can be dried at ambient conditions, in which the solvent is evaporated at room temperature. However, as the liquid evaporates from the pores, it can create a meniscus that recedes back into the gel due to the difference between interfacial energies. This may create a capillary stress on the gel, which responds by shrinking. If these forces are higher enough, they can even lead to the collapse or cracking of the whole structure. However, there are different possibilities to minimize this phenomenon. One practical solution involves the use of solvents with low surface tension to minimize the interfacial energy between the liquid and the pore. Unfortunately, not all the solvents lead to gelation, which means that some cases would require the exchange of solvent between an initial one required for the gel formation and a second one most appropriate for the drying process. Hexane is usually used as a convenient solvent for ambient drying, as its surface tension is one of the lowest among the conventional solvents.

The present invention compasses a thermal insulating material or an acoustic material comprising an organic aerogel according to the present invention.

An organic aerogel according to the present invention can be used as a thermal insulating material or acoustic material.

In highly preferred embodiment an organic aerogel according to the present invention can be used as a thermal insulating material for the storage of cryogens.

Organic aerogels according to the present invention may be used in a variety of applications such as building construction, electronics or for the aerospace industry. An organic aerogel could be used as thermal insulating material for refrigerators, freezers, automotive engines and electronic devices. Other potential applications for aerogels is as a sound absorption material and a catalyst support.

Organic aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Organic aerogels according to the present invention can also be used in construction materials due to their lightweight, strength, ability to be formed into desired shapes and superior thermal insulation properties.

Organic aerogels according to the present invention can be also used as thermal insulation for storage and transportation of cryogens.

Organic aerogels according to the present invention can be also used as an adsorption agent for oil spill clean-up, due to their high oil absorption rate.

Organic aerogels according to the present invention can be also used in safety and protective equipment as a shock-absorbing medium.

### EXAMPLES

For all the examples following test methods were used:

Thermal conductivity measured with the C-Therm TCi.

Mechanical properties (compression modulus) determined in accordance with ASTM D1621.

Density was determined as the mass of aerogel divided by the geometrical volume of aerogel.

$$Density = \frac{aerogel mass}{aerogel volume}$$

Linear shrinkage was determined as the difference between the gel and aerogel diameters divided by the gel diameter.

$$Linear shinkage ( \% ) = ( \frac{Gel diameter - Aerogel diameter}{Gel diameter} ) \cdot 100$$

### Example 1

Thiol-epoxy aerogel was prepared by PEMP (a tetrafunctional aliphatic primary thiol), Bisphenol A—diglycidyl ether (a di-functional epoxy), triethylamine (a catalyst) in acetone (a solvent). This solution was prepared with an equivalent ratio of 1:1—thiol:epoxy. The solid content of the solution was 15 wt %. The reaction is illustrated in scheme 2.

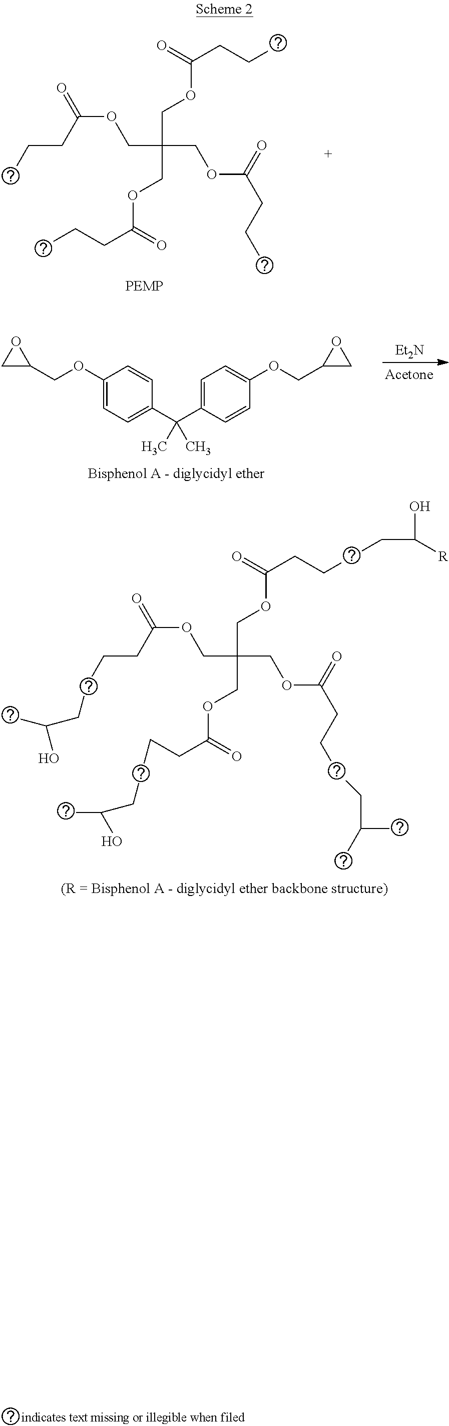

For the preparation of a sample of 30 mL, a first solution was prepared by dissolving 2.08 g of Bisphenol-A diglycidyl ether in 20.0 g of acetone and subsequently 1.30 g of PEMP was added. A second solution was prepared by dissolving 0.34 g of triethylamine in 1.05 g of acetone. The first and second solutions were mixed together, and the final solution was gelled at 45° C. in 2 days.

The resulting gel was washed three times with fresh acetone. The duration of each washing cycle was 24 h, and a volume of solvent, three times the volume of the gel, was used for each step. Subsequently the gel was dried via CO₂ supercritical drying (SCD). Table 1 illustrates measured properties of the obtained aerogel.

TABLE 1

| | Linear | Thermal | Compression |
|---|---|---|---|
| Density | shrinkage | conductivity | Modulus |
| (g/cm³) | (%) | (mW/m · K) | (MPa) |
| 0.322 | 14.47 | 53.0 | 2.78 |

### Example 2

Thiol-epoxy aerogel was prepared by 1,4-Bis(3-mercaptobutyryloxy) butane (Karenz MT BD1) (a di-functional aliphatic thiol) and Araldite MY0510 (a tri-functional epoxy), DMP-30 (a catalyst) in acetone (a solvent). This solution was prepared with an equivalent ratio of 1:5—thiol:epoxy. The solid content of the solution was 15 wt %. The reaction is illustrated in scheme 3.

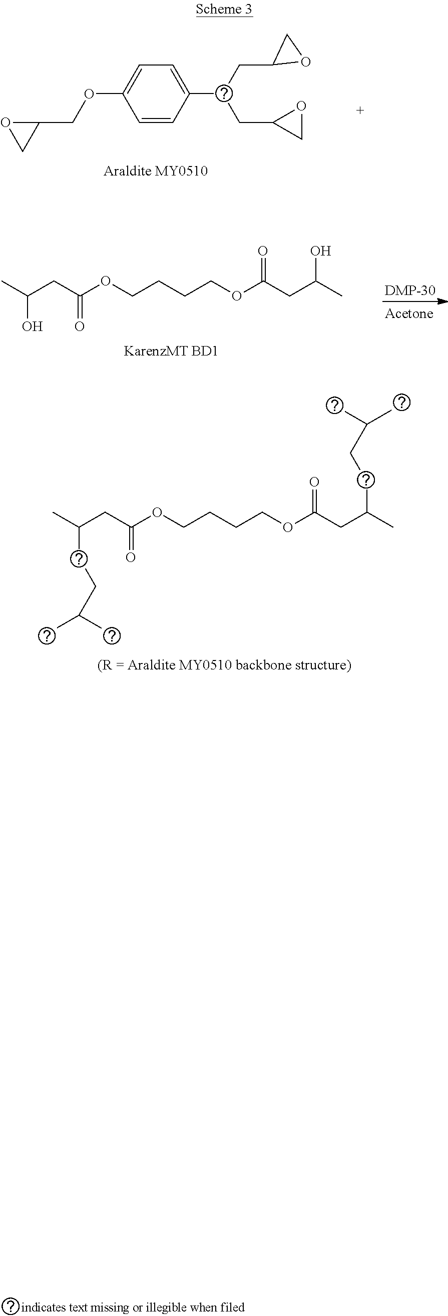

For the preparation of a sample of 30 mL, a first solution was prepared by dissolving 2.62 g of Araldite MY0510 in 20.0 g of acetone, and subsequently 0.77 g of Karenz MT BD1 was added. A second solution was prepared by dissolving 0.34 g of DMP-30 in 1.17 g of acetone. The first and second solutions were mixed, and the final solution was gelled at 45° C. in 5 days.

The resulting gel was washed three times with fresh acetone. The duration of each washing cycle was 24 h, and a volume of solvent, three times the volume of the gel, was used for each step. Subsequently the gel was dried via CO₂ supercritical drying (SCD). Table 2 illustrates measured properties of the obtained aerogel.

TABLE 2

| | Linear | Thermal | Compression |
|---|---|---|---|
| Density | shrinkage | conductivity | Modulus |
| (g/cm³) | (%) | (mW/m · K) | (MPa) |
| 0.328 | 14.89 | 47.1 | 1.73 |

### Example 3

Thiol-epoxy aerogel was prepared by PEMP (a tetrafunctional aliphatic primary thiol) and Araldite MY0510 (a tri-functional epoxy), triethanolamine (a catalyst) in N-methyl-2-pyrrolidone, NMP (a solvent). The solution was prepared with an equivalent ratio of 1:1—thiol:epoxy. The solid content of the solution was 15 wt %. The reaction is illustrated in scheme 4.

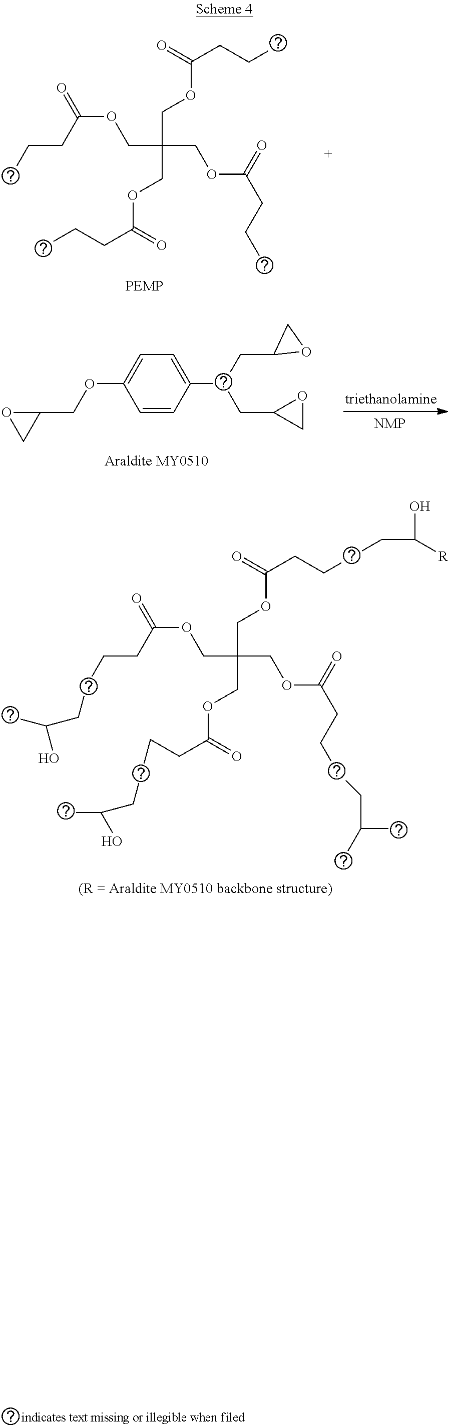

For the preparation of a sample of 30 mL, a first solution was prepared by dissolving 2.07 g of araldite MY0510 in 20.0 g of NMP, and subsequently 2.51 of PEMP was added. A second solution was prepared by dissolving 0.46 g of triethanolamine in 5.93 g of NMP. The first and second solutions were mixed, and the final solution was gelled at 65° C. in 2 days.

The gel was washed stepwise in a mixture of acetone 1:3 NMP, acetone 1:1 NMP, acetone 3:1 NMP and acetone. The duration of each step was 24 h, and a volume of solvent, three times the volume of the gel, was used for each step. Subsequently the gel was dried via CO₂ supercritical drying (SCD). Table 3 illustrates measured properties of the obtained aerogel.

TABLE 3

| | Linear | Thermal | Compression |
|---|---|---|---|
| Density | shrinkage | conductivity | Modulus |
| (g/cm³) | (%) | (mW/m · K) | (MPa) |
| 0.219 | 27.23 | 44.3 | 31.22 |

### Example 4

Thiol-epoxy aerogel was prepared by PEMP (a tetrafunctional aliphatic primary thiol) and Araldite MY0510 (a tri-functional epoxy), triethanolamine (a catalyst) in DMSO (a solvent). This solution was prepared with an equivalent ratio of 2:1—thiol:epoxy. The solid content of the solution was 15 wt %. The reaction is illustrated in scheme 5.

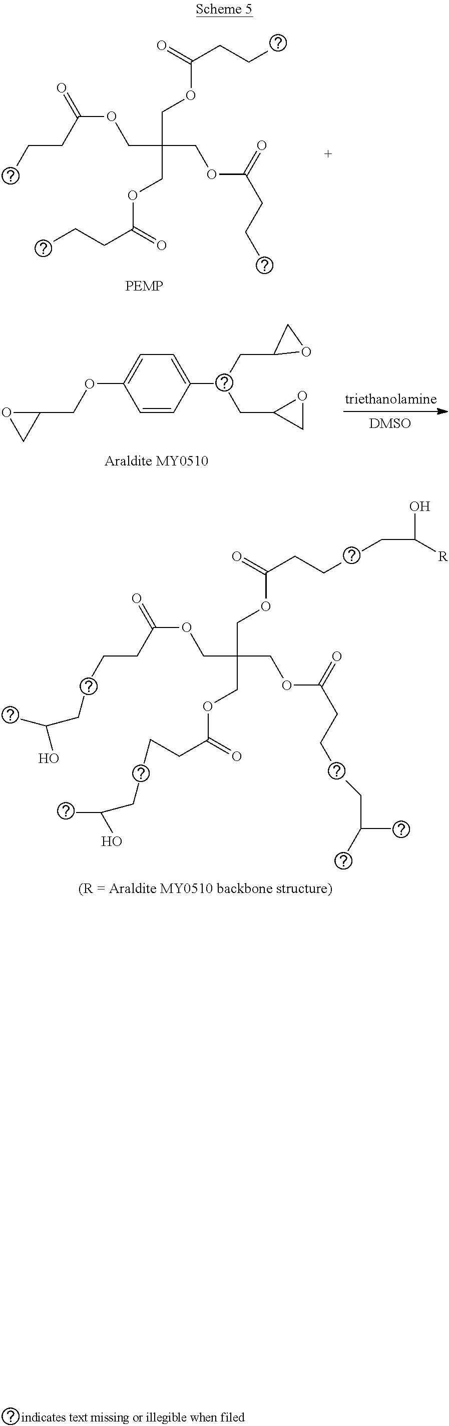

For the preparation of a sample of 30 mL, a first solution was prepared by dissolving 1.45 g of Araldite MY0510 in 20.0 g of DMSO, and subsequently 3.51 of PEMP was added. A second solution was prepared by dissolving 0.49 g of triethanolamine in 8.18 g of DMSO. The first and second solutions were mixed, and the final solution gelled at 80° C. in 1 day.

The gel was washed stepwise in a mixture of acetone 1:3 DMSO, acetone 1:1 DMSO, acetone 3:1 DMSO and acetone. The duration of each step was 24 h, and a volume of solvent, three times the volume of the gel, was used for each step. Subsequently the gel was dried via CO₂ supercritical drying (SCD). Table 4 illustrates measured properties of the obtained aerogel.

TABLE 4

| | Linear | Thermal | Compression |
|---|---|---|---|
| Density | shrinkage | conductivity | Modulus |
| (g/cm³) | (%) | (mW/m · K) | (MPa) |
| 0.829 | 44.26 | pending | 181.46 |

### Example 5

Thiol-epoxy aerogel was prepared by PEMP (a tetrafunctional aliphatic primary thiol) and Araldite MY0510 (a three-functional epoxy), benzyl alcohol (a catalyst) in DMSO (a solvent). This solution was prepared with an equivalent ratio of 1:1—thiol:epoxy. The solid content of the solution was 15 wt %. The reaction is illustrated in scheme 6.

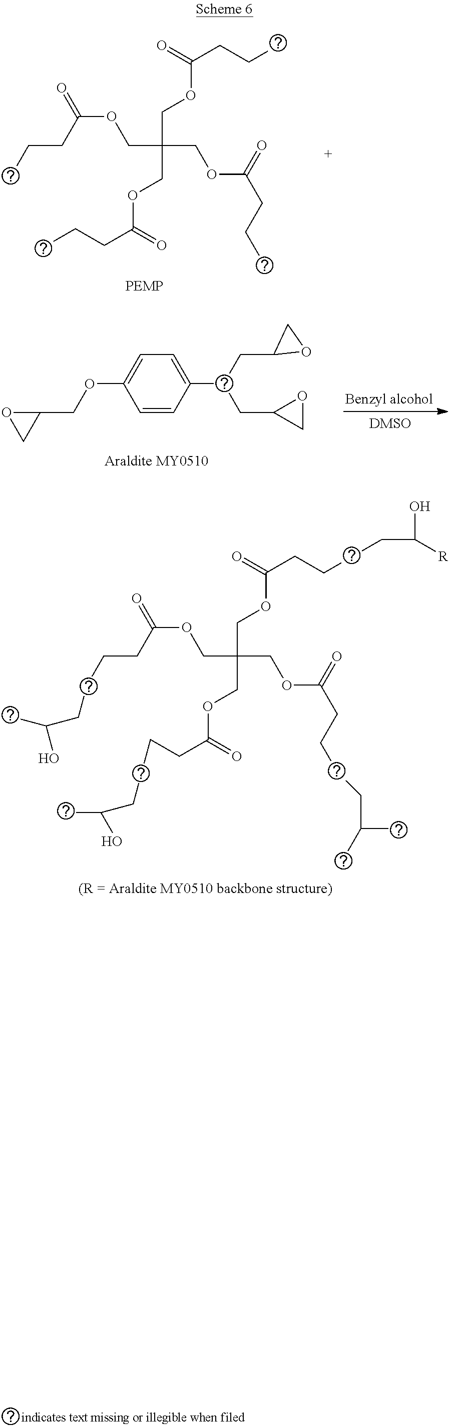

For the preparation of a sample of 30 mL, a first solution was prepared by dissolving 2.24 g of Araldite MY0510 in 20.0 g of DMSO and then 2.71 of PEMP was added. A second solution was prepared by dissolving 0.49 g of benzyl alcohol in 8.11 g of DMSO. The first and second solutions were mixed, and the final solution was gelled at 80° C. in 1 day.

The gel was washed stepwise in a mixture of acetone 1:3 DMSO, acetone 1:1 DMSO, acetone 3:1 DMSO and acetone. The duration of each step was 24 h, and a volume of solvent, three times the volume of the gel, was used for each step. Subsequently, the gel was dried via CO₂ supercritical drying (SCD). Table 5 illustrates measured properties of the obtained aerogel.

TABLE 5

| | Linear | Thermal | Compression |
|---|---|---|---|
| Density | shrinkage | conductivity | Modulus |
| (g/cm³) | (%) | (mW/m · K) | (MPa) |
| 0.257 | 29.36 | 48.6 | 2.24 |

### Example 6

The solution was composed of Araldite MY0510 (a trifunctional epoxy), chloroform, PEMP (a tetrafunctional aliphatic primary thiol) and DMBA (a catalyst). This solution was prepared with an equivalent ratio of 2:1—thiol:epoxy. The solid content of the solution was 7 wt %. The reaction is illustrated in scheme 7.

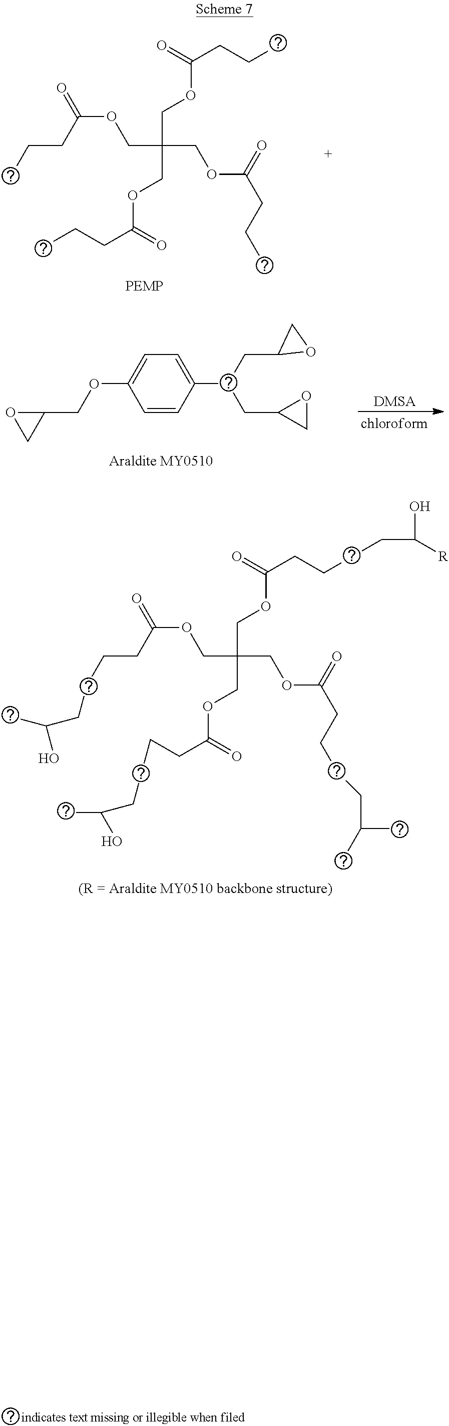

For the preparation of a sample of 30 mL, 1.39 g of Araldite MY0510 was dissolved in 40.85 g of chloroform, subsequently 1.69 g of PEMP was added and followed by incorporation of 0.12 g of DMBA. The resulting solution was placed into an oven at 45° C. for 24 hours to obtain a gel. The gel was washed stepwise in a mixture of acetone 1:3 chloroform, acetone 1:1 chloroform, acetone 3:1 chloroform and acetone. The duration of each step was 24 h, and a volume of solvent, three times the volume of the gel, was used for each step. Subsequently the gel was dried via CO₂ supercritical drying (SCD). Table 6 summarizes measured properties of the obtained aerogel.

TABLE 6

| | Linear | Thermal | Compression |
|---|---|---|---|
| Density | shrinkage | conductivity | Modulus |
| (g/cm³) | (%) | (mW/m · K) | (MPa) |
| 0.158 | 12.1 | 44.2 | 0.18 |

### Example 7

The solution was composed of Araldite MY0510 (a trifunctional epoxy), acetonitrile (solvent), PEMP (a tetrafunctional aliphatic primary thiol) and triethylamine (a catalyst). This solution was prepared with an equivalent ratio of 2:1—thiol:epoxy. The solid content of the solution was 25 wt %. The reaction is illustrated in scheme 8.

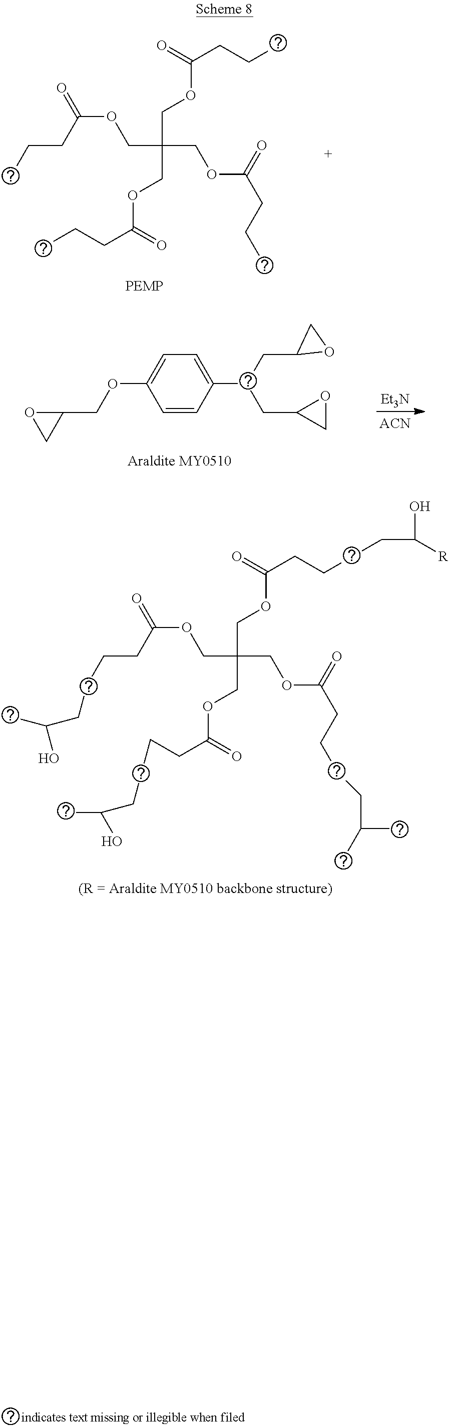

For the preparation of a sample of 30 mL, 1.84 g of Araldite MY0510 was dissolved in 18.96 g of acetonitrile, subsequently 4.48 g of PEMP was added, followed by incorporation of 0.63 g of triethylamine. The resulting solution was placed into an oven at 65° C. for 24 hours to obtain a gel. The gel was washed stepwise in a mixture of acetone 1:3 acetonitrile, acetone 1:1 acetonitrile, acetone 3:1 acetonitrile and acetone. The duration of each step was 24 h, and a volume of solvent, three times the volume of the gel, was used for each step. Subsequently the gel was dried via CO₂ supercritical drying (SCD). Table 7 illustrates measured properties of the obtained aerogel.

TABLE 7

| | Linear | Thermal | Compression |
|---|---|---|---|
| Density | shrinkage | conductivity | Modulus |
| (g/cm³) | (%) | (mW/m · K) | (MPa) |
| 0.252 | 7.9 | 49.2 | 0.80 |

### Example 8

Thiol-epoxy aerogel was prepared by PEMP (a tetrafunctional aliphatic primary thiol), Bisphenol A—diglycidyl ether (a difunctional epoxy), triethylamine (a catalyst) in acetone (a solvent). A honeycomb based on aramid fibre and phenolic resin was incorporated as reinforcements. The solution was prepared with an equivalent ratio of 1:1 thiol:epoxy. The solid content of the solution was 15 wt %. The reaction is illustrated in scheme 9.

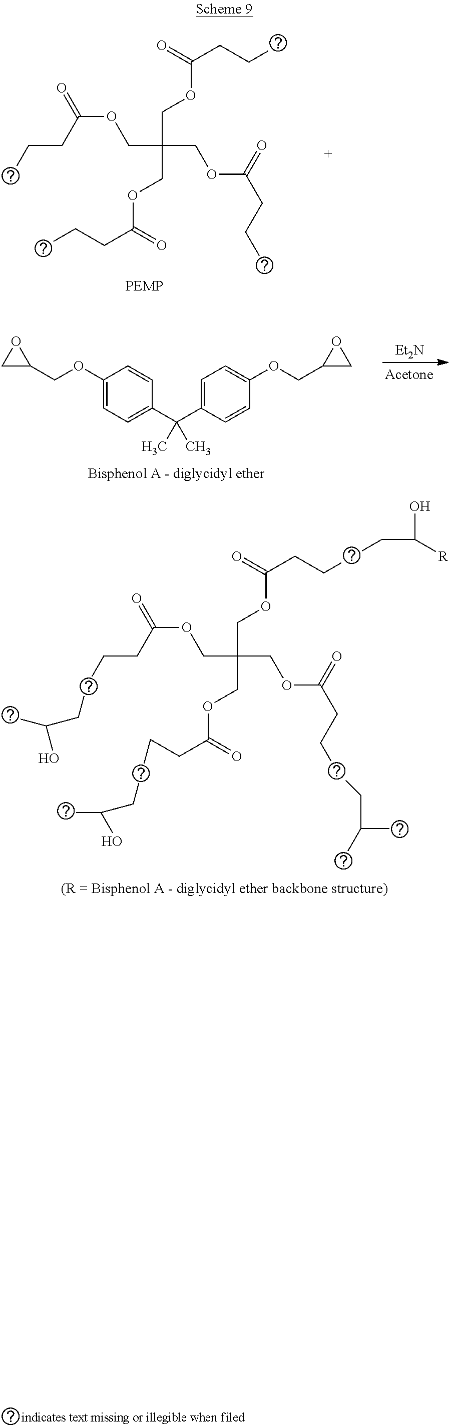

For the preparation of a sample of 30 mL, a solution was prepared by dissolving 2.27 g of bisphenol-A diglycidyl ether in 20.88 g of acetone, followed by addition of 1.42 g of PEMP and 0.37 g of triethylamine. At last, the reinforcements, honeycomb based on aramid fibre and phenolic resin were incorporated in the solution. The solution was gelled at 45° C. in 2 days.

The resulting gel was washed three times with fresh acetone. The duration of each washing was 24 h, and a volume of solvent, three times the volume of the gel, was used for each step. Subsequently the gel was dried via CO₂ supercritical drying (SCD). Table 8 illustrates measured properties of the obtained aerogel.

TABLE 8

| | Linear | Thermal | Compression |
|---|---|---|---|
| Density | shrinkage | conductivity | Modulus |
| (g/cm³) | (%) | (mW/m · K) | (MPa) |
| 0.198 | 5.0 | 48.2 | 34.7 |

### Example 9

Thiol-epoxy aerogel was prepared by PEMP (a tetrafunctional aliphatic primary thiol), Bisphenol A—diglycidyl ether (a di-functional epoxy), triethylamine (a catalyst) in acetone (a solvent). 1 wt % (based on the weight of the monomers) of clay Garamite 1958 was incorporated as a reinforcement. This solution was prepared with an equivalent ratio of 1:1—thiol:epoxy. The solid content of the solution was 15 wt %. The reaction is illustrated in scheme 10.

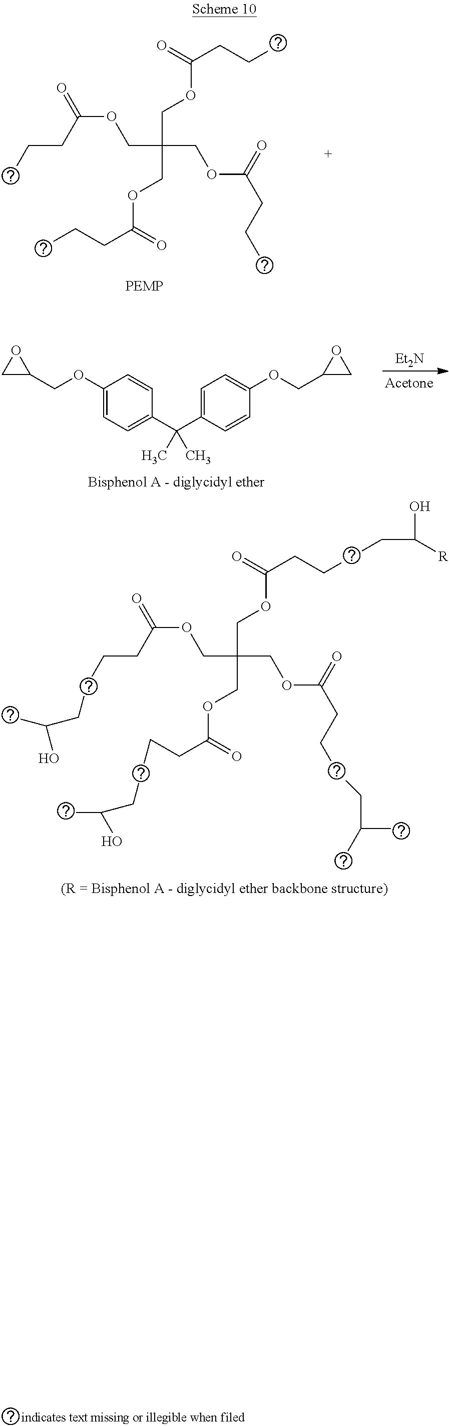

For the preparation of a sample of 30 mL, 0.037 g of clay were dispersed in 20.88 g of acetone by using a speed mixer for 3 min at 3500 rpm. Subsequently, 2.27 g of Bisphenol-A diglycidyl ether, 1.42 g of PEMP, and 0.37 g of triethylamine were incorporated in the solution. The solution was gelled at 45° C. in 2 days.

The resulting gel was washed three times with fresh acetone. The duration of each washing was 24 h, and a volume of solvent, three times the volume of the gel, was used for each step. Subsequently the gel was dried via CO₂ supercritical drying (SCD). Table 9 illustrates measured properties of the obtained aerogel.

TABLE 9

| | Linear | Thermal | Compression |
|---|---|---|---|
| Density | shrinkage | conductivity | Modulus |
| (g/cm³) | (%) | (mW/m · K) | (MPa) |
| 0.229 | 14.2 | 44.0 | 1.93 |

What is claimed is:

1. An organic aerogel obtained by reacting a thiol compound having a functionality from 2 to 6 and an epoxy compound having a functionality from 2 to 6 in a presence of a solvent.

2. An organic aerogel according to claim 1, wherein said thiol compound and said epoxy compound are reacted in the presence of a catalyst.

3. An organic aerogel according to claim 1, wherein said thiol compound has a functionality from 2 to 4 and is selected from the group consisting of 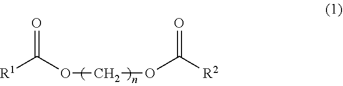
wherein n is 2-10, R¹ and R² are same or different and are independently selected from —CH₂—CH(SH)CH₃ and —CH₂—CH₂—SH; 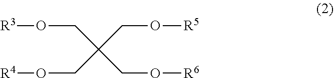
wherein R³, R⁴, R⁵ and R⁶ are same or different and are independently selected from —C(O)—CH₂—CH₂—SH, —C(O)—CH₂—CH(SH)CH₃, —CH₂—C(—CH₂—O—C(O)—CH₂—CH₂—SH)₃, —C(O)—CH₂—SH, —C(O)—CH(SH)—CH₃; 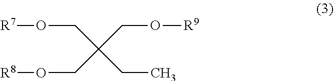
wherein R⁷, R⁸ and R⁹ are same or different and are independently selected from —C(O)—CH₂—CH₂—SH, —C(O)—CH₂—CH(SH)CH₃, —[CH₂—CH₂—O—]₀—C(O)—CH₂—CH₂—SH, —C(O)—CH₂—SH, —C(O)—CH(SH)—CH₃ and o is 1-10; 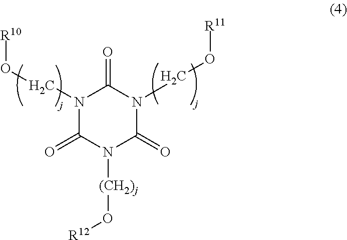
wherein j is 2-10, R¹⁰, R¹¹ and R¹² are same or different and independently selected from —CH₂—CH₂SH, —CH₂—CH(SH)CH₃, —C(O)—CH₂—SH, —C(O)—CH(SH)—CH₃ and mixtures thereof, preferably said thiol compound is selected from the group consisting of glycol di(3-mercaptopropionate), pentaerythritol tetrakis (3-mercaptobutylate). 1,3,5-tris(3-mercaptobutyloxethyl)-1,3,5-triazine-2,4,6(1H,3H,5H)-trione, 1,4-bis (3-mercaptobutylyloxy) butane, tris[2-(3-mercaptopropionyloxy)ethyl]isocyanurate, pentaerythritol tetra(3-mercaptopropionate), trimethylolpropane tris(3-mercaptopropionate), trimethylolpropane tris(3-mercaptobutyrate) ethoxylated-trimethylolpropan tri-3-mercaptopropionate, dipentaerythritol hexakis (3-mercaptopropionate) and mixtures thereof.

4. An organic aerogel according to claim 1, wherein said epoxy compound has a functionality from 2 to 4 and is selected from the group consisting of: 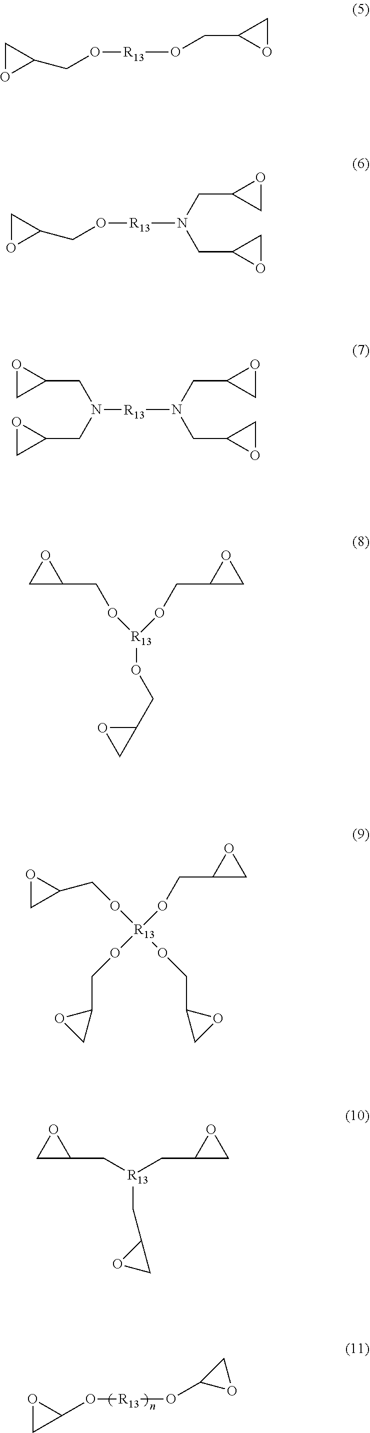
wherein R₁₃ is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is integer 1 to 30, and mixtures thereof, preferably said epoxy compound is selected from the group consisting of N,N-diglycidyl-4-glycidyloxyaniline, phenol novolac epoxy resins, tetraglycidyl ether of 1,1,2,2-tetrakis(hydroxyphenyl)ethane, N,N,N′,N′-Tetraglycidyl-4,4′-methylenebisbenzenamine, Bisphenol A—diglycidyl ether and mixtures thereof.

5. An organic aerogel according to claim 1, wherein ratio of thiol groups to epoxy groups is 10:1-1:10, preferably 6:1-1:6 and more preferably 3:1-1:3.

6. An organic aerogel according to claim 1, wherein said solvent is a polar solvent, preferably polar aprotic solvent.

7. An organic aerogel according to claim 1, wherein said catalyst is selected from the group consisting of alkyl amines, aromatic amines, imidazole derivatives, aza compounds, guanidine derivatives, benzyl alcohol and amidines.

8. An organic aerogel according to claim 1, wherein said aerogel may further comprise reinforcement selected from the group consisting of fibres, particles, non-woven and woven fibre fabrics, chopped strand mats, honeycombs, 3D structures and mixtures thereof.

9. An organic aerogel according to claim 9, wherein said reinforcement is present from 0.1 to 80% by weight of the total weight of the aerogel, preferably from 0.5 to 75%.

10. An organic aerogel according to claim 1, wherein said organic aerogel has a solid content from 4 to 40%, based on initial solid content of the solution, preferably from 4.5 to 30% and more preferably from 5 to 20%.

11. An organic aerogel according to claim 1, wherein said organic aerogel has a thermal conductivity less than 75 mW/m·K, preferably less than 55 mW/m·K, more preferably less than 50 mW/m·K, and even more preferably less than 45 mW/m·K.

12. A method for preparing an organic aerogel according to claim 1 comprising the steps of:
1) dissolving an epoxy compound into a solvent and adding a thiol compound and mixing, 2) adding a catalyst if present, and mixing;
3) letting the mixture to stand in order to form a gel;
4) washing said gel with a solvent; and
5) drying said gel by supercritical or ambient drying.

13. A method according to claim 12, wherein temperature from 20 to 120° C. is applied at step 3 to form a gel, preferably temperature from 25 to 90° C. is applied.

14. A thermal insulating material or an acoustic material comprising an organic aerogel according to claim 1.

15. Use of an organic aerogel according to claim 11 as a thermal insulating material or acoustic material.

16. Use of an organic aerogel according to claim 15 as a thermal insulating material for the storage of cryogens.
